(19) United States
(12) Patent Application Publication
(10) Pub. No.: US 2015/0043554 A1
(43) Pub. Date: Feb. 12, 2015

(54) MANAGEMENT OF INTERFACES FOR WIRELESS COMMUNICATIONS

(71) Applicant: QUALCOMM Incorporated, San Diego, CA (US)

(72) Inventors: Arnaud Meylan, San Diego, CA (US); Manu Sharma, San Diego, CA (US); Satashu Goel, San Diego, CA (US); Jay Kumar Sundararajan, San Diego, CA (US)

(73) Assignee: QUALCOMM Incorporated, San Diego, CA (US)

(21) Appl. No.: 13/961,074

(22) Filed: Aug. 7, 2013

(51) Int. Cl. H04W 88/06

(52) U.S. Cl. CPC H04W 88/06
USPC 370/338

(57) ABSTRACT

Methods, systems, and apparatuses are described for managing interfaces for wireless communications. In one method, at least one active interface of a user equipment (UE) may be used for the wireless communications. While using the at least one active interface, a need for increased bandwidth for the wireless communications may be detected. Based at least in part upon detecting the need for increased bandwidth, at least one additional interface of the UE may be activated for use in the wireless communications. More than one of the active interfaces of the UE may be simultaneously used for the wireless communications, and may be used independent of network coordination of the active interfaces.

### BACKGROUND

Wireless communications systems are widely deployed to provide various types of communication content, such as voice, video, packet data, messaging, broadcast, and so on. In some cases, a user equipment (a UE; e.g., a mobile device) may have more than one physical interface, such as a first interface for wirelessly communicating over a wireless communications system using a first radio access technology, and a second interface for wirelessly communicating over the wireless communications system using a second radio access technology. For example, a UE may have both a cellular interface and a wireless local area network (WLAN) interface. Each interface may carry traffic to and/or from the UE.

When the UE is out of the coverage area of access points using the radio access technology supported by one of the interfaces, the UE may be able to access services via an access point using the radio technology supported by the other one of the interfaces.

In some cases, the UE may be within the coverage areas of both 1) access points using the radio access technology of one of the interfaces, and 2) access points using the radio access technology of the other of the interfaces. In these cases, the UE may access services via either of the interfaces.

### SUMMARY

The described features generally relate to one or more improved methods, systems, and/or apparatuses for managing interfaces for wireless communications.

A method for managing interfaces for wireless communications is described. In one configuration, at least one active interface of a user equipment (UE) may be used for wireless communications. While using the at least one active interface, a need for increased bandwidth for the wireless communications may be detected at the UE. At least in part upon detecting the need for increased bandwidth, at least one additional interface of the UE may be activated for use in the wireless communications. More than one of the active interfaces of the UE may be simultaneously used for the wireless communications. The active interfaces may be used independent of network coordination of the active interfaces.

In some embodiments, detecting the need for increased bandwidth may include detecting a round trip time of wireless communications exceeds a threshold.

In some embodiments, detecting the need for increased bandwidth may include detecting a size of a transmit queue exceeds a threshold.

In some embodiments, detecting the need for increased bandwidth may include detecting a share of downlink resources in a system exceeds a threshold.

In some embodiments, detecting the need for increased bandwidth may include detecting a ratio of achieved throughput over estimated available bandwidth exceeds a threshold.

In some embodiments, detecting the need for increased bandwidth may include detecting information on at least one application running on the UE. Detecting information on at least one application may include detecting a particular application running in a foreground of an operating system of the UE. Detecting information on at least one application may also include detecting a particular combination of applications running in an operating system of the UE.

In some embodiments, detecting the need for increased bandwidth may include detecting poor video performance.

In some embodiments, an indication that at least one active interface is unable to provide increased bandwidth may be received from a network, and the at least one additional interface may be activated based at least in part on the indication.

In some embodiments, wireless communication loads may be balanced across two or more of the active interfaces.

In some embodiments, at least one of the interfaces may include a wireless local area network (WLAN) interface.

In some embodiments, at least one of the interfaces may include a cellular interface.

An apparatus for managing interfaces for wireless communications is also described. In one configuration, the apparatus may include a means for using at least one active interface of a UE for the wireless communications; a means for detecting at the UE, while using the at least one active interface, a need for increased bandwidth for the wireless communications; and a means for activating, based at least in part upon detecting the need for increased bandwidth, at least one additional interface of the UE for use in the wireless communications; and means for simultaneously using more than one of the active interfaces of the UE for the wireless communications. The active interfaces being used independent of network coordination of the active interfaces.

Another apparatus for managing interfaces for wireless communications is also described. The apparatus may include a processor, a memory in electronic communications with the processor, and instructions embodied in the memory. The instructions may be executable by the processor to use at least one active interface of a UE for the wireless communications; detect at the UE, while using the at least one active interface, a need for increased bandwidth for the wireless communications; activate, based at least in part upon detecting the need for increased bandwidth, at least one additional interface of the UE for use in the wireless communications; and simultaneously use more than one of the active interfaces of the UE for the wireless communications. The active interfaces may be used independent of network coordination of the active interfaces.

A computer program product for managing interfaces for wireless communications is also described. The computer program product may include a non-transitory computer-readable medium storing instructions executable by a processor to use at least one active interface of a user equipment (UE) for the wireless communications; detect at the UE, while using the at least one active interface, a need for increased bandwidth for the wireless communications; activate, based at least in part upon detecting the need for increased bandwidth, at least one additional interface of the UE for use in the wireless communications; and simultaneously use more than one of the active interfaces of the UE for the wireless communications. The active interfaces may be used independent of network coordination of the active interfaces.

Further scope of the applicability of the described methods and apparatuses will become apparent from the following detailed description, claims, and drawings. The detailed description and specific examples are given by way of illustration only, since various changes and modifications within the spirit and scope of the description will become apparent to those skilled in the art.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of a wireless communications system;

FIG. 2 shows a block diagram of a user equipment for managing interfaces for wireless communications in accordance with various embodiments;

FIG. 3 shows a block diagram of a receiver module and a transmitter module providing multiple interfaces for wireless communications in accordance with various embodiments;

FIG. 4 shows a block diagram of another user equipment for managing interfaces for wireless communications in accordance with various embodiments;

FIG. 5 shows a block diagram of yet another user equipment for managing interfaces for wireless communications in accordance with various embodiments;

FIG. 6 shows a message flow diagram illustrating one embodiment of communications between a user equipment and first and second access points, in accordance with various embodiments;

FIG. 7 is a block diagram of a MIMO communication system in accordance with various embodiments; and

FIGS. 8-11 are flowcharts of methods for managing interfaces for wireless communications, in accordance with various embodiments.

### DETAILED DESCRIPTION

Management of interfaces for use in wireless communication is described. When a UE has more than one physical interface, the UE may typically use one interface at a time. For example, a UE having both a WLAN interface (e.g., a Wi-Fi interface) and a cellular interface may use the WLAN interface until communications over the WLAN interface become poor, and then switch communications to the cellular interface. Alternately, the UE may periodically assess which interface is providing the fastest service (e.g., as measured by round trip times of communications transmitted and received via the different interfaces). The UE may then choose to use the fastest of the interfaces for wireless communication.

Disclosed herein are methods, systems, and apparatuses for managing a UE's interfaces so that at least one additional interface may be activated and used for wireless communications, in addition to at least one interface that is already active, when a need for increased bandwidth exists. The need for increased bandwidth may in some cases be detected by monitoring one or more parameters of the UE, including parameters related to its connections and/or running applications.

The following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

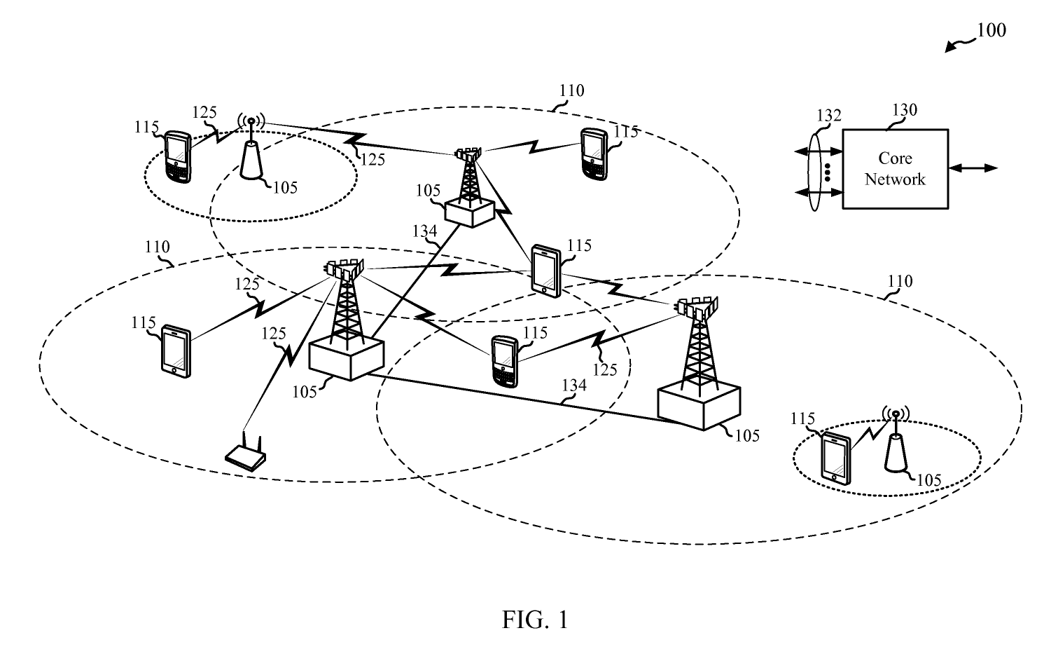

Referring first to FIG. 1, a diagram illustrates an example of a wireless communications system 100. The system 100 includes a plurality of access points (e.g., base stations, eNBs, or WLAN access points) 105, a number of user equipments (UEs) 115, and a core network 130. Some of the access points 105 may communicate with the UEs 115 under the control of a base station controller (not shown), which may be part of the core network 130 or certain access points 105 (e.g., base stations or eNBs) in various embodiments. Some of the access points 105 may communicate control information and/or user data with the core network 130 through backhaul 132. In some embodiments, some of the access points 105 may communicate, either directly or indirectly, with each other over backhaul links 134, which may be wired or wireless communication links. The system 100 may support operation on multiple carriers (waveform signals of different frequencies). Multi-carrier transmitters can transmit modulated signals simultaneously on the multiple carriers. For example, each communication link 125 may be a multi-carrier signal modulated according to various radio technologies. Each modulated signal may be sent on a different carrier and may carry control information (e.g., reference signals, control channels, etc.), overhead information, data, etc.

The access points 105 may wirelessly communicate with the UEs 115 via one or more access point antennas. Each of the access points 105 may provide communication coverage for a respective coverage area 110. In some embodiments, an access point 105 may be referred to as a base station, a base transceiver station (BTS), a radio base station, a radio transceiver, a basic service set (BSS), an extended service set (ESS), a NodeB, an evolved NodeB (eNB), a Home NodeB, a Home eNodeB, a WLAN access point, or some other suitable terminology. The coverage area 110 for an access point may be divided into sectors making up only a portion of the coverage area (not shown). The system 100 may include access points 105 of different types (e.g., macro, micro, and/or pico base stations). The access points 105 may also utilize different radio technologies, such as cellular and/or WLAN radio access technologies. The access points 105 may be associated with the same or different access networks. The coverage areas of different access points 105, including the coverage areas of the same or different types of access points 105, utilizing the same or different radio technologies, and/or belonging to the same or different access networks, may overlap.

In some embodiments, the system 100 may include an LTE/LTE-A communications system (or network). In LTE/LTE-A communications systems, the term evolved Node B (eNB) may be generally used to describe one of the access points 105. The system 100 may also be a Heterogeneous LTE/LTE-A network in which different types of eNBs provide coverage for various geographical regions. For example, each eNB 105 may provide communication coverage for a macro cell, a pico cell, a femto cell, and/or other types of cell. A macro cell generally covers a relatively large geographic area (e.g., several kilometers in radius) and may allow unrestricted access by UEs with service subscriptions with the network provider. A pico cell would generally cover a relatively smaller geographic area and may allow unrestricted access by UEs with service subscriptions with the network provider. A femto cell would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). An eNB for a macro cell may be referred to as a macro eNB. An eNB for a pico cell may be referred to as a pico eNB. And, an eNB for a femto cell may be referred to as a femto eNB or a home eNB. An eNB may support one or multiple (e.g., two, three, four, and the like) cells.

The core network 130 may communicate with the eNBs 105 via a backhaul 132 (e.g., S1, etc.). The eNBs 105 may also communicate with one another, e.g., directly or indirectly via backhaul links 134 (e.g., X2, etc.) and/or via backhaul 132 (e.g., through core network 130). The wireless communications system 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time. The techniques described herein may be used for either synchronous or asynchronous operations.

The UEs 115 may be dispersed throughout the wireless communications system 100, and each UE 115 may be stationary or mobile. A UE 115 may also be referred to by those skilled in the art as a mobile device, a mobile station, a subscriber station, a mobile unit, a subscriber unit, a wireless unit, a remote unit, a wireless device, a wireless communication device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wearable item such as a watch or glasses, a wireless local loop (WLL) station, or the like. A UE 115 may be able to communicate with macro eNBs, pico eNBs, femto eNBs, relays, and the like. A UE 115 may also be able to communicate over different access networks, such as cellular or other WWAN access networks, or WLAN access networks.

The communication links 125 shown in system 100 may include uplinks for carrying uplink (UL) transmissions (e.g., from a UE 115 to an eNB 105) and/or downlinks for carrying downlink (DL) transmissions (e.g., from an eNB 105 to a UE 115). The UL transmissions may also be called reverse link transmissions, while the DL transmissions may also be called forward link transmissions.

In some cases, a UE 115 may be capable of managing more than one interface for wireless communications. For example, while using at least one active interface for wireless communications, a UE 115 may detect a need for increased bandwidth. At least in part upon detecting the need for increased bandwidth, the UE 115 may activate at least one additional interface for use in the wireless communications. More than one of the active interfaces may then be used simultaneously, independent of network coordination. In some cases, at least one of the interfaces may be a WLAN interface and at least one of the interfaces may be a cellular (e.g., LTE) interface. When the need for increased bandwidth no longer exists, or when the available battery life of the UE 115 is low, the use of one or more interfaces may be discontinued.

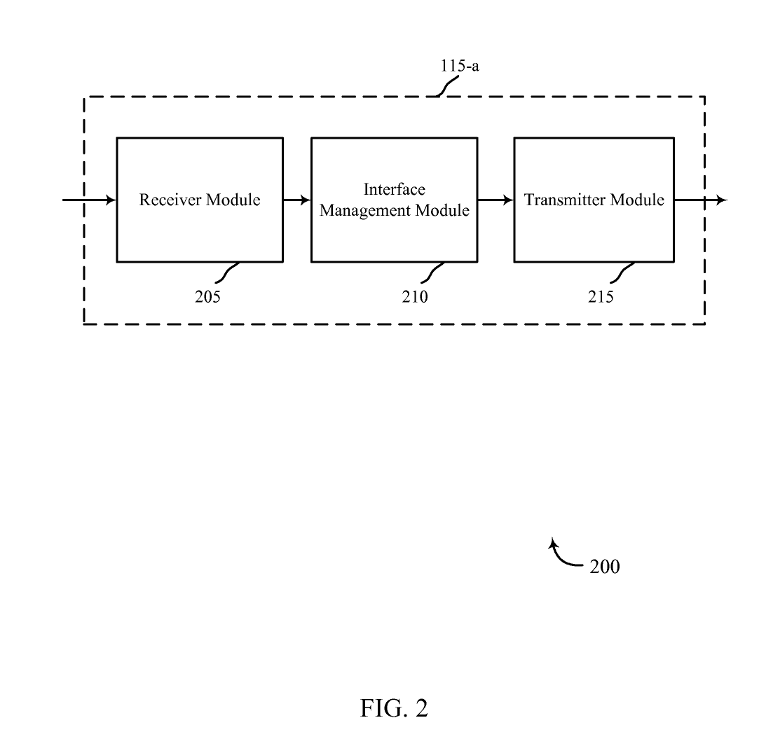

Referring now to FIG. 2, a block diagram 200 illustrates a UE 115-a capable of managing interfaces for wireless communications, in accordance with various embodiments. The UE 115-a may be an example of one or more aspects of one of the UEs 115 described with reference to FIG. 1. The UE 115-a may also be a processor. The UE 115-a may include a receiver module 205, an interface management module 210, and/or a transmitter module 215. Each of these components may be in communication with each other.

The components of the UE 115-a may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

The receiver module 205 may include any number or types of receivers, and in some cases may include two or more wireless receivers, such as a cellular receiver and a wireless local area network (WLAN) receiver. In some cases, the cellular receiver may be or include an LTE/LTE-A receiver. The receiver module 205 may be used to receive various types of data and/or control signals (i.e., transmissions) over one or more communication channels of a wireless communications system, such as the wireless communications system 100 described with reference to FIG. 1.

The transmitter module 215 may include any number or types of transmitters, and in some cases may include two or more wireless transmitters, such as a cellular transmitter and a WLAN transmitter. In some cases, the cellular transmitter may be or include an LTE/LTE-A transmitter. The transmitter module 215 may be used to transmit various types of data and/or control signals over one or more communication channels of a wireless communications system, such as the wireless communications system 100.

The interface management module 210 may perform various functions. In some embodiments, the interface management module 210 may manage a number of interfaces of the receiver module 205 and/or the transmitter module 215 and may, for example, activate, deactivate, operate, and/or control the interfaces of the receiver module 205.

In some embodiments, the interface management module 210 may activate at least one interface of the UE 115-a for wireless communications. The at least one active interface may in some cases include components of the receiver module 205 and/or the transmitter module 215. At some point in time, and while the UE 115-a is using the at least one active interface for the wireless communications, the interface management module 210 may detect a need of the UE 115-a for increased bandwidth for the wireless communications. At least in part upon detecting the need for increased bandwidth, the interface management module 210 may activate at least one additional interface for the UE 115-a (or certain processes and/or applications of the UE 115-a) to use for wireless communications. In some embodiments, at least one of the interfaces may be a WLAN interface and at least one of the interfaces may be a cellular interface.

After activating the at least one additional interface, the active interfaces may be used for wireless communications in parallel, or in an alternating or ad hoc manner. Some applications may utilize both interfaces, while other applications may use only one of the interfaces. In some cases, the interface management module 210 may attempt to balance the wireless communication loads across two or more of the active interfaces and/or allocate higher priority communications to a faster one of the interfaces. The active interfaces may be used independent of network coordination of the interfaces.

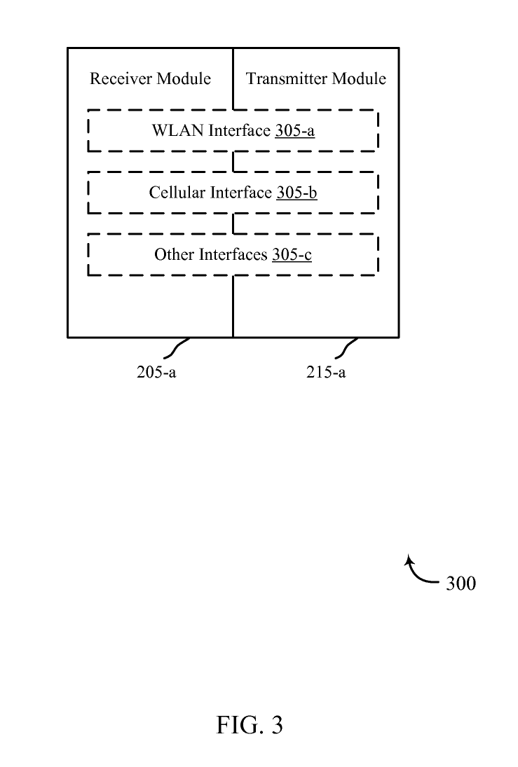

FIG. 3 is a block diagram 300 illustrating examples of the various interfaces 305-a, 305-b, 305-c that may be implemented by a receiver module 205-a and a transmitter module 215-a. In some embodiments, the receiver module 205-a and the transmitter module 215-a may be examples of one or more aspects of the receiver module 205 and the transmitter module 215 described with reference to FIG. 2. By way of example, at least one interface 305-a may be a WLAN interface and at least one other interface 305-b may be a cellular interface. Other interfaces (e.g., interface 305-c) may also be implemented.

Although each of the interfaces shown in FIG. 3 is shown to include a receiver component (e.g., part of the receiver module 205-a) and a transmitter component (e.g., part of the transmitter module 215-a), an interface may in some cases include only a receiver component or a transmitter component.

The components of the interfaces 305-a, 305-b, and/or 305-c may, individually or collectively, be implemented with one or more ASICs adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, FPGAs, and other Semi-Custom ICs), which may be programmed in any manner known in the art. The functions of each unit may also be implemented, in whole or in part, with instructions embodied in a memory, formatted to be executed by one or more general or application-specific processors.

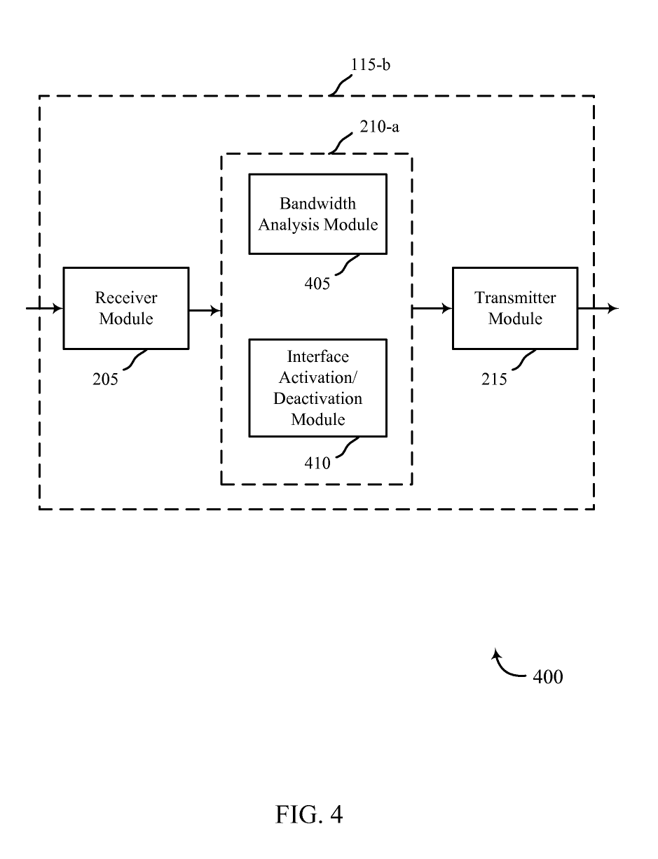

Referring now to FIG. 4, a block diagram 400 illustrates a UE 115-b capable of managing interfaces for wireless communications, in accordance with various embodiments. The UE 115-b may be an example of one or more aspects of one of the UEs 115 described with reference to FIG. 1. The UE 115-b may also be a processor. The UE 115-b may include a receiver module 205, an interface management module 210-a, and/or a transmitter module 215. Each of these components may be in communication with each other.

The components of the UE 115-b may, individually or collectively, be implemented with one or more ASICs adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, FPGAs, and other Semi-Custom ICs), which may be programmed in any manner known in the art. The functions of each unit may also be implemented, in whole or in part, with instructions embodied in a memory, formatted to be executed by one or more general or application-specific processors.

The receiver module 205 and transmitter module 215 may be configured similarly to what is described with respect to FIGS. 2 and/or 3. The interface management module 210-a may be an example of one or more aspects of the interface management module 210 described with reference to FIG. 2 and may include a bandwidth analysis module 405 and/or an interface activation/deactivation module 410.

The bandwidth analysis module 405 may detect a need for increased bandwidth while the UE 115-b is using at least one active interface for wireless communications. In some cases, the bandwidth analysis module 405 may detect the need for increased bandwidth by monitoring one or more parameters of the UE 115-b and/or its connections, such as the round trip time of wireless communications initiated by or with the UE 115-b.

At least in part upon detecting the need for increased bandwidth, the bandwidth analysis module 405 may indicate its detection of a need for increased bandwidth to the interface activation/deactivation module 410 or otherwise cause the interface activation/deactivation module 410 to activate at least one additional interface for the wireless communications.

The bandwidth analysis module 405 may also detect when the need for increased bandwidth no longer exists, and may indicate this detection to the interface activation/deactivation module 410 and/or otherwise cause the interface activation/deactivation module 410 to deactivate one or more interfaces.

The interface activation/deactivation module 410 may activate at least one additional interface for the UE 115-b (or certain processes and/or applications of the UE 115-b) to use for wireless communications. The activation may occur, for example, in response to an indication from the bandwidth analysis module 405 that additional bandwidth is needed, or in response to a signal indicating that at least one additional interface should be activated. The deactivation may occur, for example, in response to an indication from the bandwidth analysis module 405 that the additional bandwidth is no longer needed, or in response to a signal indicating that use of one or more interfaces (e.g., one or more of the at least one additional interface) should be discontinued. In some cases, interfaces may be activated or deactivated one at a time (e.g., a need for increased bandwidth, or the absence of a need for the currently available bandwidth, may be assessed before each interface activation or deactivation).

After the interface activation/deactivation module 410 activates the at least one additional interface, the active interfaces may be used for wireless communications in parallel, or in an alternating or ad hoc manner. Some applications may utilize two or more of the active interfaces, while other applications may use only one of the active interfaces. In some cases, the interface activation/deactivation module 410 may attempt to balance the wireless communication loads across two or more of the active interfaces and/or allocate higher priority communications to a faster one of the interfaces.

In some embodiments, the bandwidth analysis module 405 and/or interface activation/deactivation module 410 may be implemented using a connection manager, a modem, and/or an operating system of the UE 115-b.

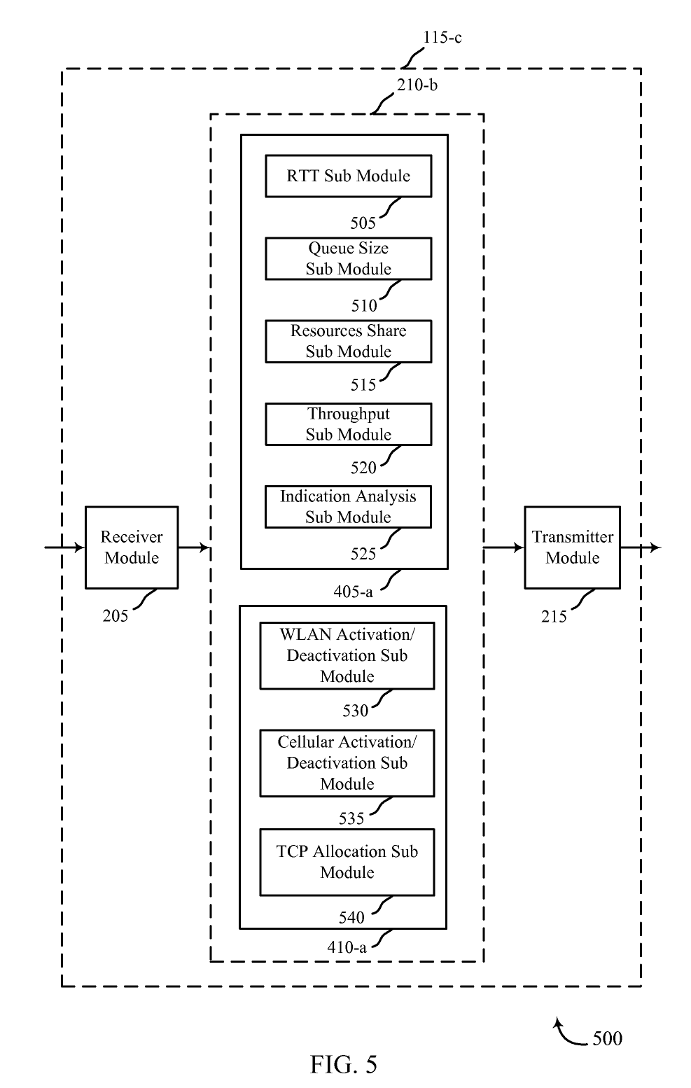

Referring now to FIG. 5, a block diagram 500 illustrates a UE 115-c capable of managing interfaces for wireless communications, in accordance with various embodiments. The UE 115-c may be an example of one or more aspects of one of the UEs 115 described with reference to FIGS. 1, 2, and/or 4. The UE 115-c may also be a processor. The UE 115-c may include a receiver module 205, an interface management module 210-b, and/or a transmitter module 215. Each of these components may be in communication with each other.

The components of the UE 115-c may, individually or collectively, be implemented with one or more ASICs adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, FPGAs, and other Semi-Custom ICs), which may be programmed in any manner known in the art. The functions of each unit may also be implemented, in whole or in part, with instructions embodied in a memory, formatted to be executed by one or more general or application-specific processors.

The receiver module 205 and transmitter module 215 may be configured similarly to what is described with respect to FIGS. 2 and/or 3. The interface management module 210-b may be an example of one or more aspects of the interface management module 210 described with reference to FIGS. 2 and/or 4 and may include a bandwidth analysis module 405-a and/or an interface activation/deactivation module 410-a. The bandwidth analysis module 405-a and interface activation/deactivation module 410-a may be examples of one or more aspects of the respective bandwidth analysis module 405 and interface activation/deactivation module 410 described with reference to FIG. 4.

The bandwidth analysis module 405-a may detect a need for increased bandwidth while the UE 115-c is using at least one active interface for wireless communications. In some cases, the bandwidth analysis module 405-a may detect the need for increased bandwidth by monitoring one or more parameters of the UE 115-c and/or its connections. In this regard, the bandwidth analysis module 405-a may include a round trip time (RTT) sub module 505, a queue size sub module 510, a resources share sub module 515, a throughput sub module 520, and/or an indication analysis sub module 525.

The RTT sub module 505 may monitor a round trip time of wireless communications between the UE 115-c and an access point (e.g., one of the aspect points described with reference to FIG. 1), and may detect when an RTT of the wireless communications exceeds a threshold. In some cases, the RTT may be an RTT of a particular wireless communication. In other cases, the RTT may be an average RTT for a plurality of wireless communications (e.g., a running average of RTTs over the past five minutes). In still other cases, the RTT may be an average or combined RTT for the set of active interfaces. Upon detecting that the RTT exceeds the threshold (and in some cases other parameters), the RTT sub module 505 may cause the interface activation/deactivation module 410-a to activate at least one additional interface for use in the wireless communications. Similarly, and upon detecting that the RTT has fallen below a threshold (and in some cases other parameters), the RTT sub module 505 may cause the interface activation/deactivation module 410-a to deactivate one or more interfaces. In some cases, the RTT sub module 505 may initiate one or more wireless communications for the particular purpose of monitoring the RTTs of one or more active interfaces. In other cases, the RTT sub module 505 may monitor the RTTs of wireless communications initiated for other purposes (e.g., the RTT of wireless communications initiated by applications running on the UE 115-c). In either case, the RTT sub module 505 may monitor the RTT of wireless communications made using the at least one active interface of the UE 115-c.

The queue size sub module 510 may monitor the size of a transmit queue for wireless communications between the UE 115-c and an access point 105 (e.g., the size of a transmit queue for at least one active interface of the UE 115-c), and may detect when the size of the transmit queue exceeds a threshold. Upon detecting that the size of the transmit queue exceeds the threshold (and in some cases other parameters), the queue size sub module 510 may cause the interface activation/deactivation module 410-a to activate at least one additional interface for use in the wireless communications. Similarly, and upon detecting that the size of the transmit queue has fallen below a threshold (and in some cases other parameters), the queue size sub module 510 may cause the interface activation/deactivation module 410-a to deactivate one or more interfaces. In some cases, each of a number of transmit queues for different active interfaces may be monitored, and an interface may be activated or deactivated if the size of any one transmit queue, or the size of a transmit queue incorporating all of the interface-specific transmit queues, exceeds or falls below a particular threshold.

The resources share sub module 515 may monitor the share of resources used by the UE 115-c for wireless communications between the UE 115-c and an access point 105 (e.g., the share of resources used by at least one of the active interfaces of the UE 115-c with respect to the resources available to all UEs using the same air interface and/or backhaul as the at least one active interface), and may detect when the share of resources exceeds a threshold. Upon detecting that the share of resources exceeds the threshold (and in some cases other parameters), the resources share sub module 515 may cause the interface activation/deactivation module 410-a to activate at least one additional interface for use in the wireless communications. Similarly, and upon detecting that the share of resources used has fallen below a threshold (and in some cases other parameters), the resources share sub module 515 may cause the interface activation/deactivation module 410-a to deactivate one or more interfaces. The resources share sub module 515 may consider the share of resources used for the uplink and/or downlink of at least one of the active interfaces of the UE 115-c.

In some embodiments, the resources share sub module 515 may determine whether the share of resources allocable to the UE 115-c is subject to increase by adding a wireless communications flow to an active interface of the UE 115-c (e.g., a full-buffer active probe-upload or download) and determining whether the bandwidth allocated to the UE 115-c increases to service the flow. When the bandwidth allocated to the UE 115-c does not increase, or increases very little, the resources share sub module 515 may cause the interface activation/deactivation module 410-a to activate at least one additional interface.

The throughput sub module 520 may monitor the throughput of wireless communications between the UE 115-c and an access point 105 (e.g., the throughput of at least one of the active interfaces of the UE 115-c), and may detect when the throughput exceeds a threshold (e.g., when the throughput is above a specified fraction of the estimated available bandwidth). Upon detecting that the throughput exceeds the threshold (and in some cases other parameters), the throughput sub module 520 may cause the interface activation/deactivation module 410-a to activate at least one additional interface for use in the wireless communications. Similarly, and upon detecting that the throughput has fallen below a threshold (and in some cases other parameters), the throughput sub module 520 may cause the interface activation/deactivation module 410-a to deactivate at least one interface.

The thresholds upon which a particular sub module (e.g., the sub module 505, 510, 515, or 520) activates or deactivates the at least one additional interface may be the same or different.

The indication analysis sub module 525 may analyze various indications received by the bandwidth analysis module 405-a. For example, upon one or more of the sub modules 505, 510, 515, and/or 520 detecting a need for increased bandwidth, the bandwidth analysis module 405-a may send a request for increased bandwidth to a network. In these cases, the indication analysis sub module 525 may be used to determine whether an indication to use at least one additional interface has been received. The indication may be received from the network to which the request for increased bandwidth was sent. When the indication analysis sub module 525 determines that the indication has been received, the indication analysis sub module 525 may cause the interface activation/deactivation module 410-a to activate at least one additional interface. In some cases, the indication to use the at least one additional interface may take the form of an indication that the network is unable to provide additional or enough bandwidth via at least one active interface of the UE 115-c.

In some embodiments, the indication analysis sub module 525 may analyze an indication or indications of a need for increased bandwidth received from one or more applications running on the UE 115-c. An indication of a need for increased bandwidth may, in some examples, take the form of an indication that: bandwidth is needed now; bandwidth is needed from now until some later time (or for a particular duration of time); a particular bandwidth is needed; and/or a particular bandwidth is needed. The indication that a particular bandwidth is needed may be coupled with an indication that bandwidth beyond a certain value cannot be used or would not be useful. For example, an application may provide an indication or indications that an additional 500 kilobytes per second (kbps) is needed to play a video; that an additional 1 megabyte per second (Mbps) would help play the video better; and that any additional bandwidth would make no difference to the application. In some cases, an application may provide an indication of a need for increased bandwidth (and even wait for a response) before indicating to a user (e.g., by displaying a spinning wheel or hourglass) that the application is stalled pending the availability of more bandwidth.

The indication analysis sub module 525 may also receive an indication such as an indication that an application needs a lower RTT for its communications, or an indication that an application needs lower jitter. In some cases, the indications provided by an application may cause the indication analysis sub module 525 to trigger the activation of at least one additional interface even when bandwidth remains available via an already-active interface (e.g., because jitter of at least one active interface is too high).

The indication analysis sub module 525 may also receive an indication that an application prefers not to be handed over from one interface to another. In such a case, the indication analysis sub module 525 may in some cases override the determination(s) of one or more other sub modules 525 to activate at least one additional interface. Alternately, the indication analysis sub module 525 may indicate to the interface activation/deactivation module 410-a the preference of the application.

The bandwidth analysis module 405-a may also or alternately detect a need for increased bandwidth in other ways. For example, the module 405-a may infer from an application's repeated attempts to access a medium (e.g., in the cases of a WLAN interface) or repeated requests for an uplink grant (e.g., in the case of a cellular or LTE interface) that increased bandwidth is needed. In some cases, the module 405-a may base a determination to activate at least one additional interface at least partly on the measured time from medium access request (or request for uplink grant) to receipt of medium access or uplink grant exceeding a threshold. The module 405-a may also infer from gaps in TCP sequence numbers while an interface is not losing packets that increased bandwidth is needed.

The bandwidth analysis module 405-a may also infer a need for increased bandwidth based on information pertaining to at least one application running on the UE 115-c. For example, information such as the identity of a particular application running in the foreground of an operating system of the UE 115-c; a particular combination of applications running in the operating system of the UE 115-c; the number open sockets or connections; the number of outstanding HTTP GET requests; video performance; and/or web browser performance. For example, if a video playback application (e.g., Netflix®, YouTube®) is running in the foreground of an operating system, the bandwidth analysis module 405-a may infer that the need for increased bandwidth is high, but if an on-device game is running in the foreground, the bandwidth analysis module 405-a may infer that the need for increased bandwidth is low. The bandwidth analysis module 405-a may also infer, for example, that more bandwidth is needed when a particular combination of applications is running, e.g., an application update process and a web browser. The bandwidth analysis module 405-a may also infer that the opening of several sockets or connections by one or more applications indicates a need for increased bandwidth. The bandwidth analysis module 405-a may also infer from the number of outstanding HTTP GET requests exceeding a threshold that a need for increased bandwidth exists. In some cases, the number of outstanding HTTP GET requests may be averaged over time when determining whether their number exceeds a threshold. The bandwidth analysis module 405-a may also monitor the video performance of the UE 115-c, and infer from the video performance whether a need for increased bandwidth exists. Poor video performance may be inferred, for example, based on a reduction of video code rate, frequent video stalls, and/or a playback buffer status (e.g., is the playback buffer getting full?). The bandwidth analysis module 405-a may also monitor the performance of a web browser running on the UE 115-c. Poor web browser performance may be inferred, for example, based on poor page load time statistics. The bandwidth analysis module 405-a may also detect a need for increased bandwidth based on how the web browser has been configured (e.g., has the web browser been configured to pre-load certain images, pages, and/or websites, in which case increased bandwidth may be needed).

In some embodiments, the bandwidth analysis module 405-a may further determine or infer whether an application or applications running on the UE 115-c are capable of using increased bandwidth. For example, when an application is not able to use more than one TCP connection at a time and its single TCP connection cannot be split across multiple interfaces, the application may not be able to communicate via more than one interface, and the activation of an additional interface may not be useful (or the benefits of activating the additional interface may not outweigh its costs).

In some embodiments, the bandwidth analysis module 405-a may determine not to activate an additional interface despite there being a need for increased bandwidth. For example, the bandwidth analysis module may determine that, despite a need for increased bandwidth, the available power of the UE 115-c and/or other costs outweigh the benefits of activating the at least one additional interface.

In some embodiments (and as previously described), the bandwidth analysis module 405-a may no longer detect a need for increased bandwidth and indicate to the interface activation/deactivation module 410-a that use of one or more interfaces may be discontinued. Other parameters that may be assessed when determining whether to discontinue use of one or more interfaces may include, for example, a drop in the duty cycle of a particular interface below a threshold, or an assessment that the duty cycles of the active interfaces do not justify the continued use of one or more interfaces. A particular drop in the fraction of time that traffic is received over an interface may also justify discontinuing use of the interface. A determination that the bandwidth used by all applications is less than the available bandwidth of fewer than all active interfaces may also justify discontinuing the use of one or more interfaces. Use of an interface may also be discontinued when the available battery power of the UE 115-c falls below a threshold.

The bandwidth analysis module 405-a may in some cases provide an application programming interface (API) or inter-process communications (IPC) socket, which API or APC socket enable an application to provide its indication(s) of a need for increased bandwidth. An application may also provide indications that a need for increased bandwidth no longer exists.

The interface activation/deactivation module 410-a may activate or deactivate an interface for the UE 115-a (or certain processes and/or applications of the UE 115-a) to use for wireless communications. In this regard, the interface activation/deactivation module 410-a may include a WLAN activation/deactivation sub module 530, a cellular activation/deactivation sub module 535, and/or a transmission control protocol (TCP) allocation sub module 540.

The WLAN activation/deactivation sub module 530 may activate or deactivate a WLAN interface, which in some cases may be one of the additional interfaces used for wireless communications by the UE 115-c. In other cases, the WLAN interface may be one of the initial interfaces used for wireless communications by the UE 115-c. In some embodiments, activation of the WLAN interface may include the establishment of communication with an access point 105 to which the WLAN interface connects. As part of establishing communication with the access point 105, the UE 115-c may transmit a connection request to the access point 105.

The cellular activation/deactivation sub module 535 may activate or deactivate a cellular interface, which in some cases may be one of the additional interfaces used for wireless communications by the UE 115-c. In other cases, the cellular interface may be one of the initial interfaces used for wireless communications by the UE 115-c. In some embodiments, activation of the cellular interface may include the establishment of communication with a base station 105 to which the cellular interface connects. As part of establishing communication with the base station 105, the UE 115-c may transmit a connection request to the base station 105.

The TCP allocation sub module 540 may allocate TCP connections or flows across the active interfaces. In some cases, the TCP allocation sub module 540 may attempt to balance wireless communication loads across two or more of the active interfaces by allocating TCP connections to the active interfaces in a round robin manner. For purposes of this description, the process of “balancing” wireless communications loads includes processes that attempt to equalize wireless communication loads across multiple interfaces as well as processes that attempt to optimize the allocation of wireless communication loads across multiple interfaces to improve utilization and/or performance of the interfaces and/or the applications that are using the interfaces. Although not as sophisticated as some allocation methods, a round robin allocation may sometimes provide as good or better load balancing as other allocation methods given a lack of knowledge of the throughput required for each connection. TCP connections may in some cases be allocated to each of the interfaces in equal numbers or in an alternating manner. In other cases, the TCP connections may be allocated using an offset round robin approach (e.g., where three TCP connections are allocated to one interface and then two TCP connections are allocated to another interface, or where six TCP connections are allocated to one interface and then four TCP connections are allocated to another interface).

In some embodiments, the TCP allocation sub module 540 may attempt to balance wireless communication loads across two or more active interfaces by allocating a number of TCP connections to each interface based at least in part on an estimated available bandwidth of each interface. TCP connections may also be allocated such that a TCP connection that is consuming the most bandwidth (or is likely to) is allocated to the interface capable of providing the most bandwidth or the interface having the most available bandwidth.

In some embodiments, the TCP allocation sub module 540 may attempt to balance wireless communication loads across two or more active interfaces by allocating an application TCP connections from two or more interfaces. In some cases, the application running in the foreground on the UE 115-c may receive such an allocation of TCP connections.

The TCP allocation sub module 540 may in some cases allocate new TCP connections in one or more of the above manners. The TCP allocation sub module 540 may also, and in some cases, rebalance existing TCP connections in one or more of the above manners. When active interfaces use the same internet protocol (IP) address, rebalancing may occur at any time, but should not occur so often that it hurts the transport layer of the UE 115-c. When active interfaces do not use the same IP address, rebalancing may not occur without shutting a connection down and reactivating it, which may be undesirable.

In some embodiments, the bandwidth analysis module 405-a and/or interface activation/deactivation module 410-a may be implemented using a connection manager, a modem, and/or an operating system of the UE 115-c.

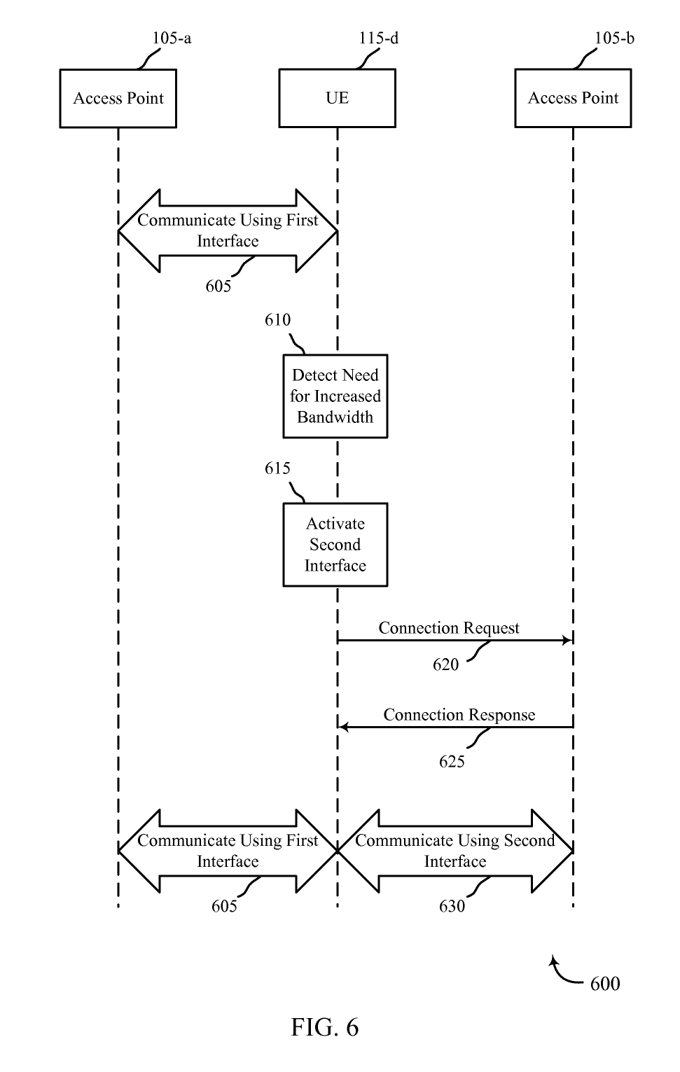

FIG. 6 is a message flow diagram 600 illustrating one embodiment of wireless communications between a first access point 105-a, a UE 115-d, and a second access point 105-b. The access points 105-a, 105-b may be examples of one or more aspects of the access point(s) 105 described with reference to FIG. 1. The UE 115-d may be an example of one or more aspects of the UE(s) 115 described with reference to FIGS. 1, 2, 4, and/or 5.

In one configuration, the UE 115-d may use a first interface to engage in wireless communications 605 with the first access point 105-a.

At block 610, and while using the first interface, the UE 115-d may detect a need for increased bandwidth for the wireless communications. In some embodiments, the need for increased bandwidth may be detected using the interface management module 210 described with reference to FIGS. 2, 4, and/or 5, and/or the bandwidth analysis module 405 described with reference to FIGS. 4 and/or 5.

At block 615, and based at least in part upon detecting the need for increased bandwidth, the UE 115-d may e.g. activate a second interface for use in the wireless communications. After activating the second interface, or as a part of the activation process, the UE 115-d may send a connection request 620 to the second access point 105-b. Upon acceptance of the connection request 620, the second access point may return a connection response 625 indicating that a connection between the UE 115-d and second access point 105-b may be established. In some embodiments, the second interface may be activated using the interface management module 210 described with reference to FIGS. 2, 4, and/or 5, and/or the interface activation/deactivation module 410 described with reference to FIGS. 4 and/or 5.

Upon establishing a connection between the UE 115-d and the second access point 105-b, the UE 115-d may use the second interface to engage in wireless communications 630 with the second access point 105-b. At the same time (e.g., in parallel, or in an alternating or ad hoc manner), the UE 115-d may continue to use the first interface to engage in wireless communications 605 with the first access point 105-a. The first and second interfaces may be used independent of network coordination of the interfaces.

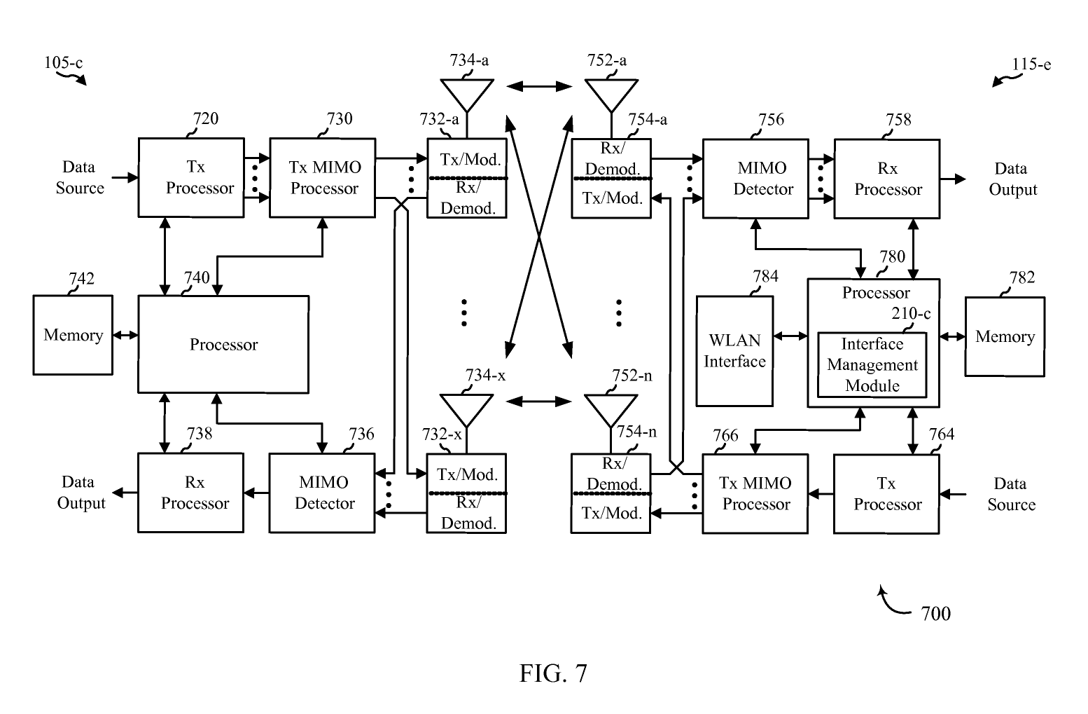

FIG. 7 is a block diagram of a MIMO communication system 700 including a base station 105-c and a UE 115-e. This system 700 may be an example of one or more aspects of the system 100 described with reference to FIG. 1. The UE 115-e may be one example of the UE 115 described in relation to FIGS. 1, 2, 4, 5, and/or 6. The base station 105-c may be equipped with antennas 734-a through 734-x, and the UE 115-e may be equipped with antennas 752-a through 752-n. In the system 700, the base station 105-c may be able to send data over multiple communication links at the same time. Each communication link may be called a “layer”, and the “rank” of the communication link may indicate the number of layers used for communication. For example, in a 2×2 MIMO system where base station 105-c transmits two “layers,” the rank of the communication link between the base station 105-c and the UE 115-e is two.

At the base station 105-c, a transmit processor 720 may receive data from a data source. The transmit processor 720 may process the data. The transmit processor 720 may also generate control symbols and/or reference symbols. A transmit (TX) MIMO processor 730 may perform spatial processing (e.g., precoding) on data symbols, control symbols, and/or reference symbols, if applicable, and may provide output symbol streams to the transmit modulators 732-a through 732-x. Each modulator 732 may process a respective output symbol stream (e.g., for OFDM, etc.) to obtain an output sample stream. Each modulator 732 may further process (e.g., convert to analog, amplify, filter, and upconvert) the output sample stream to obtain a DL signal. In one example, DL signals from modulators 732-a through 732-x may be transmitted via the antennas 734-a through 734-x, respectively.

At the UE 115-e, the UE antennas 752-a through 752-n may receive the DL signals from the base station 105-c and may provide the received signals to the demodulators 754-a through 754-n, respectively. Each demodulator 754 may condition (e.g., filter, amplify, downconvert, and digitize) a respective received signal to obtain input samples. Each demodulator 754 may further process the input samples (e.g., for OFDM, etc.) to obtain received symbols. A MIMO detector 756 may obtain received symbols from all the demodulators 754-a through 754-n, perform MIMO detection on the received symbols, if applicable, and provide detected symbols. A receive processor 758 may process (e.g., demodulate, deinterleave, and decode) the detected symbols, providing decoded data for the UE 115-e to a data output, and provide decoded control information to a processor 780, or memory 782.

The processor 780 may in some cases execute stored instructions to instantiate an interface management module 210-c. In some embodiments, the interface management module 210-c may be an example of one or more aspects of the interface management module 210 described with reference to FIGS. 2, 4, and/or 5. In some embodiments, the interface management module 210-c may activate, deactivate, and/or manage at least first and second interfaces of the UE 115-e. The interfaces may be used for wireless communications of the UE 115-e and may include, for example, a WLAN interface 784 and a cellular interface. The cellular interface may include, for example, one or more of the antennas 752-a through 752-n, the modulators/demodulators 754-a through 754-n, the MIMO detector 756, the receive processor 758, the transmit processor 764, and/or the MIMO processor 766. The interface management module 210-c may in some cases manage the use of at least a first interface for wireless communications, such as the WLAN interface 784. The interface management module 210-c may also analyze the bandwidth requirements of the UE 115-e, and at least in part upon detecting a need for increased bandwidth, activate at least the second interface for use in the wireless communications. The second interface may in some cases be a cellular interface.

On the uplink (UL), at the UE 115-e, a transmit processor 764 may receive and process data from a data source. The received data may in some cases include the estimated characteristic(s) of one or more communication channels. The transmit processor 764 may also generate reference symbols for a reference signal. The symbols from the transmit processor 764 may be precoded by a transmit MIMO processor 766 if applicable, further processed by the modulators 754-a through 754-n (e.g., for SC-FDMA, etc.), and be transmitted to the base station 105-c in accordance with the transmission parameters received from the base station 105-c. At the base station 105-c, the UL signals from the UE 115-e may be received by the antennas 734, processed by the demodulators 732, detected by a MIMO detector 736 if applicable, and further processed by a receive processor. The receive processor 738 may provide decoded data to a data output and to the processor 740.

The components of the UE 115-e may, individually or collectively, be implemented with one or more ASICs adapted to perform some or all of the applicable functions in hardware. Each of the noted modules may be a means for performing one or more functions related to operation of the system 700. Similarly, the components of the base station 105-c may, individually or collectively, be implemented with one or more ASICs adapted to perform some or all of the applicable functions in hardware. Each of the noted components may be a means for performing one or more functions related to operation of the system 700.

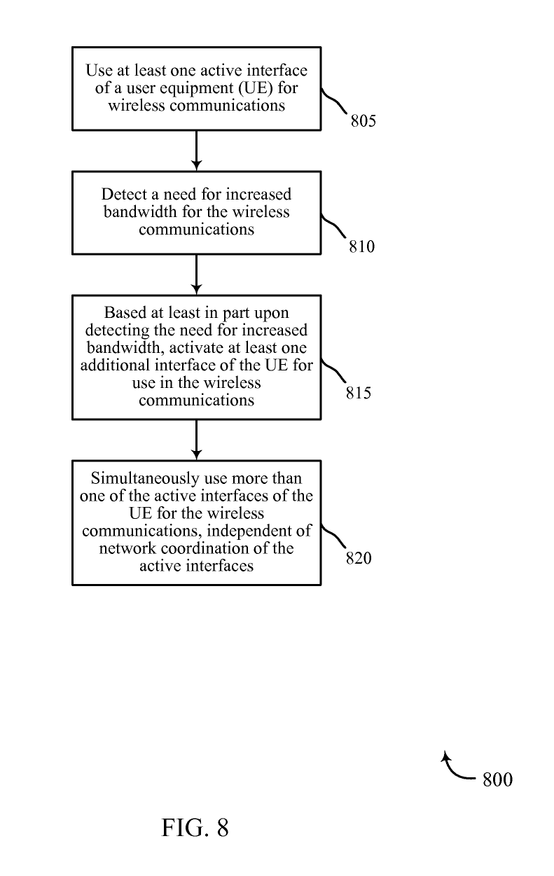

FIG. 8 is a flow chart illustrating a method 800 for managing interfaces for wireless communications. For clarity, the method 800 is described below with reference to one of the UEs 115 described with reference to FIGS. 1, 2, 4, 5, 6, and/or 7. In one implementation, the interface management module 210 described with reference to FIGS. 2, 4, 5, and/or 7 may execute one or more sets of codes to control the functional elements of a UE 115 to perform the functions described below.

At block 805, at least one active interface of a UE 115 may be used for wireless communications.

At block 810, and while using the at least one active interface, a need for increased bandwidth for the wireless communications may be detected at the UE 115. In some embodiments, the need for increased bandwidth may be detected using the bandwidth analysis module 405 described with reference to FIGS. 4 and/or 5.

At block 815, and based at least in part upon detecting the need for increased bandwidth, at least one additional interface of the UE 115 may be activated for use in the wireless communications. In some cases, one additional interface may be activated at a time. In some embodiments, the operation(s) at block 815 may be performed using the interface activation/deactivation module 410 described with reference to FIGS. 4 and/or 5.

At block 820, more than one of the active interfaces of the UE 115 may be simultaneously used for the wireless communications. The active interfaces may be used independent of network coordination of the active interfaces. In some embodiments, the operation(s) at block 820 may be performed using the interface management module 210 described with reference to FIGS. 2, 4, and/or 5.

In some embodiments, the active interfaces of the UE 115 may be interfaces such as the interfaces 305 described with reference to FIG. 3. In some cases, the at least one active interface at block 805 may be or include a WLAN interface and the at least one additional interface activated at block 815 may be or include a cellular interface. In other cases, the at least one active interface at block 805 may be or include a cellular interface and the at least one additional interface activated at block 815 may be or include a WLAN interface. Alternately, the interfaces may take other forms.

Therefore, the method 800 may be used for managing interfaces for wireless communications. It should be noted that the method 800 is just one implementation and that the operations of the method 800 may be rearranged or otherwise modified such that other implementations are possible.

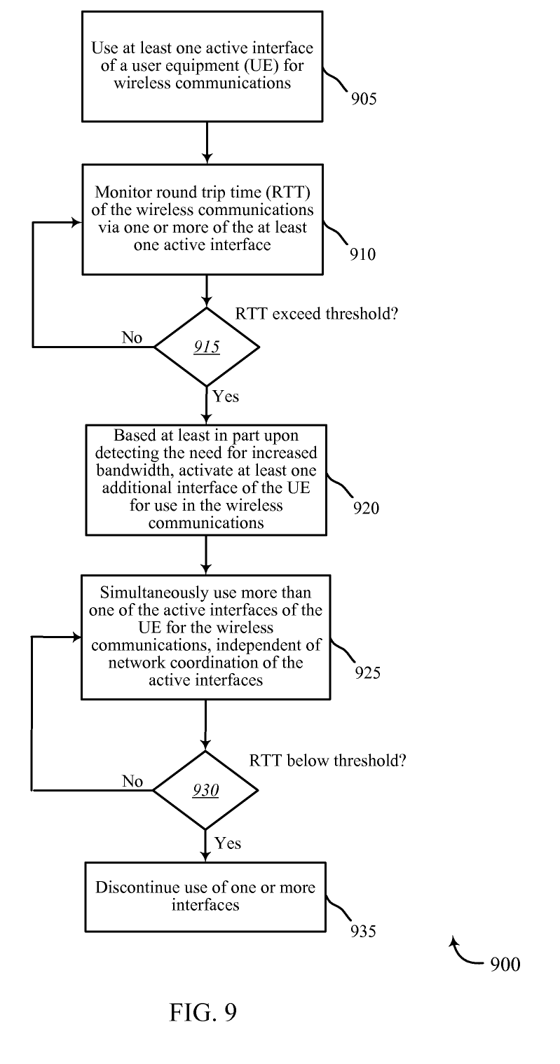

FIG. 9 is a flow chart illustrating another method 900 for managing interfaces for wireless communications. For clarity, the method 800 is described below with reference to one of the UEs 115 described with reference to FIGS. 1, 2, 4, 5, 6, and/or 7. In one implementation, the interface management module 210 described with reference to FIGS. 2, 4, 5, and/or 7 may execute one or more sets of codes to control the functional elements of a UE 115 to perform the functions described below.

At block 905, at least one active interface of a UE 115 may be used for wireless communications.

At blocks 910 and 915, and while using the at least one active interface, a need for increased bandwidth for the wireless communications may be detected at the UE 115. In some cases, and as shown, the need for increased bandwidth may be detected by monitoring a round trip time (RTT) of the wireless communications via one or more of the at least one active interface at block 910. Then, and at block 915, it may be determined whether the RTT for one or more of the active interfaces (or an average or combined RTT for the set of active interfaces) exceeds a threshold. When the RTT does not exceed the threshold, operation of the method 900 may return to block 910 and RTT monitoring may continue. However, when the RTT exceeds the threshold, operation of the method 900 may continue to block 920. In some embodiments, the need for increased bandwidth may be detected using the bandwidth analysis module 405 described with reference to FIGS. 4 and/or 5. In some embodiments, the operation(s) at block 910 and/or 915 may be performed using the RTT sub module 505 described with reference to FIG. 4.

At block 920, and at least in part upon determining that the RTT exceeds the threshold, at least one additional interface may be added for use in the wireless communications. In some cases, one additional interface may be activated at a time. In some embodiments, the operation(s) at block 920 may be performed using the interface activation/deactivation module 410 described with reference to FIGS. 4 and/or 5.

At block 925, more than one of the active interfaces of the UE 115 may be simultaneously used for the wireless communications. The active interfaces may be used independent of network coordination of the active interfaces. In some embodiments, the operation(s) at block 925 may be performed using the interface management module 210 described with reference to FIGS. 2, 4, and/or 5.

In some embodiments, the active interfaces of the UE 115 may be interfaces such as the interfaces 305 described with reference to FIG. 3. In some cases, the at least one active interface at block 905 may be or include a WLAN interface and the at least one additional interface activated at block 920 may be or include a cellular interface. In other cases, the at least one active interface at block 905 may be a cellular interface and the at least one additional interface activated at block 920 may be a WLAN interface. Alternately, the interfaces may take other forms.

At block 930, it may be determined whether the RTT has fallen below a threshold, which threshold may be the same as, or different from, the threshold used in the determination at block 915. When the RTT has not fallen below the threshold, the method 900 may loop at block 925, and simultaneous use of more than one of the active interfaces may continue. However, when the RTT has fallen below the threshold, operation of the method 900 may continue to block 935. In some embodiments, the determination made at block 930 may be made by the RTT sub module 505.

At block 935, and based at least in part upon determining that the RTT has fallen below the threshold, the use of one or more interfaces for the wireless communications may be discontinued. In some cases, the use of interfaces may be discontinued one interface at a time. In some embodiments, the operation(s) at block 930 may be performed by the interface activation/deactivation module 410.

In some embodiments of the method 900, a need for increased bandwidth may also or alternately be detected at blocks 910 and 915 by monitoring or detecting: a size of a transmit queue or queues (e.g., a size of a transmit queue or queues of the UE 115); a share of downlink resources in a system (e.g., a share of downlink resources used by the UE 115); a ratio of achieved throughput over estimated available bandwidth (e.g., for the UE 115); and/or information on at least one application running on the UE (e.g., information on a particular application running in the foreground of an operating system, or information on a particular combination of applications running in the operating system). At least one additional interface may then be added based at least in part upon determining that one or more of these monitored parameters has exceeded a respective threshold and/or that a particular application or applications are running. Similarly, use of the at least one additional interface may be discontinued based at least in part upon determining that one or more of the monitored parameters has fallen below a respective threshold and/or that a particular application or applications are no longer running.

Therefore, the method 900 may be used for managing interfaces for wireless communications. It should be noted that the method 900 is just one implementation and that the operations of the method 900 may be rearranged or otherwise modified such that other implementations are possible.

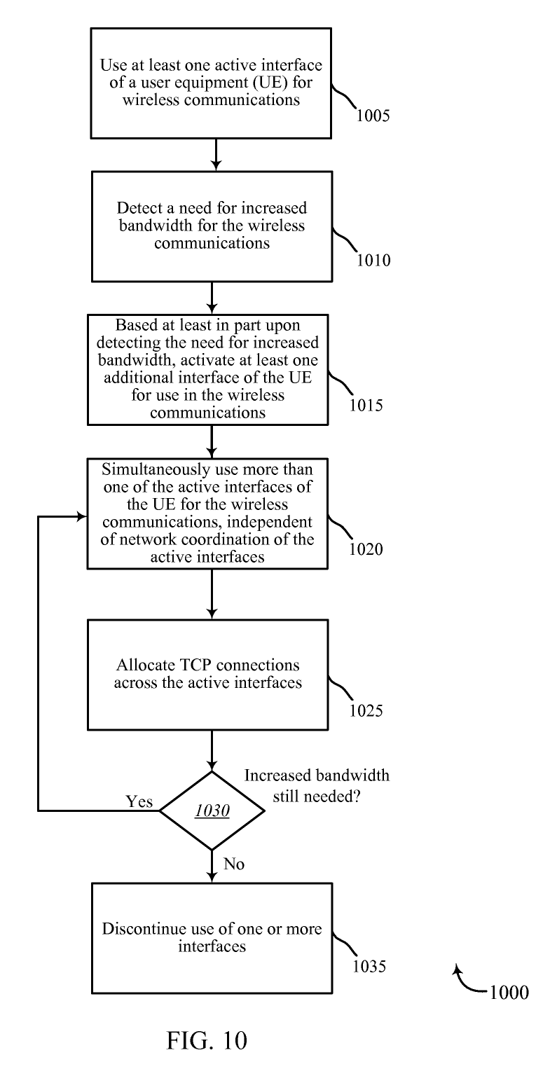

FIG. 10 is a flow chart illustrating yet another method 1000 for managing interfaces for wireless communications. For clarity, the method 1000 is described below with reference to one of the UEs 115 described with reference to FIGS. 1, 2, 4, 5, 6, and/or 7. In one implementation, the interface management module 210 described with reference to FIGS. 2, 4, 5, and/or 7 may execute one or more sets of codes to control the functional elements of a UE 115 to perform the functions described below.

At block 1005, at least one active interface of a UE 115 may be used for wireless communications.

At block 1010, and while using the at least one active interface, a need for increased bandwidth for the wireless communications may be detected at the UE 115. In some embodiments, the need for increased bandwidth may be detected using the bandwidth analysis module 405 described with reference to FIGS. 4 and/or 5.

At block 1015, and based at least in part upon detecting the need for increased bandwidth, at least one additional interface of the UE 115 may be activated for use in the wireless communications. In some cases, one additional interface may be activated at a time. In some embodiments, the operation(s) at block 1015 may be performed using the interface activation/deactivation module 410 described with reference to FIGS. 4 and/or 5.

At block 1020, more than one of the active interfaces of the UE 115 may be simultaneously used for the wireless communications. The active interfaces may be used independent of network coordination of the active interfaces. In some embodiments, the operation(s) at block 1020 may be performed using the interface management module 210 described with reference to FIGS. 2, 4, and/or 5.

In some embodiments, the active interfaces of the UE 115 may be interfaces such as the interfaces 305 described with reference to FIG. 3. In some cases, the at least one active interface at block 1005 may be or include a WLAN interface and the at least one additional interface activated at block 1015 may be or include a cellular interface. In other cases, the at least one active interface at block 1005 may be or include a cellular interface and the at least one additional interface activated at block 1015 may be or include a WLAN interface. Alternately, the interfaces may take other forms.

At block 1025, TCP connections may be allocated across the active interfaces. The TCP connections may be allocated in an attempt to balance wireless communication loads across two or more of the active interfaces. In some embodiments, TCP connections may be allocated by the TCP allocation sub module 540 described with reference to FIG. 5.

At block 1030, it may be determined whether the increased bandwidth provided by the at least one additional interface is still needed. When the increased bandwidth is still needed, the method 1000 may loop at blocks 1020 and 1025, where simultaneous use of more than one of the active interfaces may continue. However, when the need for increased bandwidth no longer exists, operation of the method 1000 may continue to block 1035. In some embodiments, the determination made at block 1030 may be made by the bandwidth analysis module 405.

At block 1035, and based at least in part upon determining that the need for increased bandwidth no longer exists, the use of one or more interfaces for the wireless communications may be discontinued. In some cases, the use of interfaces may be discontinued one interface at a time. In some embodiments, the operation(s) at block 1030 may be performed by the interface activation/deactivation module 410.

Therefore, the method 1000 may be used for managing interfaces for wireless communications. It should be noted that the method 1000 is just one implementation and that the operations of the method 1000 may be rearranged or otherwise modified such that other implementations are possible.

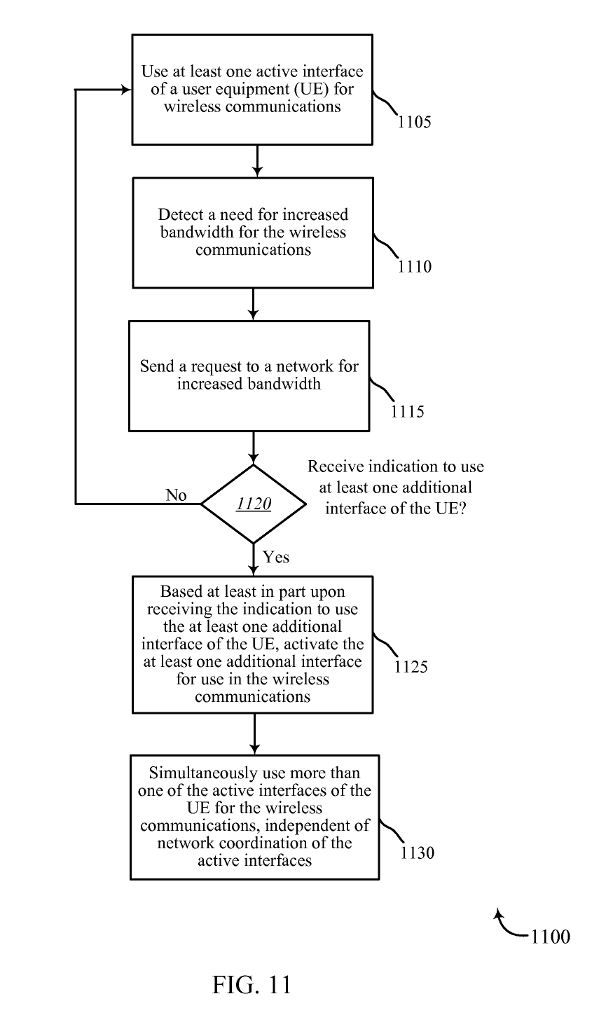

FIG. 11 is a flow chart illustrating another method 1100 for managing interfaces for wireless communications. For clarity, the method 1100 is described below with reference to one of the UEs 115 described with reference to FIGS. 1, 2, 4, 5, 6, and/or 7. In one implementation, the interface management module 210 described with reference to FIGS. 2, 4, 5, and/or 7 may execute one or more sets of codes to control the functional elements of a UE 115 to perform the functions described below.

At block 1105, at least one active interface of a UE 115 may be used for wireless communications.

At block 1110, and while using the at least one active interface, a need for increased bandwidth for the wireless communications may be detected at the UE 115. In some embodiments, the need for increased bandwidth may be detected using the bandwidth analysis module 405 described with reference to FIGS. 4 and/or 5.

At block 1115, and based at least in part upon detecting the need for increased bandwidth, a request for increased bandwidth may be sent to a network. In some embodiments, the request may be sent by the bandwidth analysis module 405 described with reference to FIGS. 4 and/or 5.

At block 1120, it may be determined whether an indication to use at least one additional interface for the wireless communications has been received. The indication may be received from the network to which the request for increased bandwidth was sent. When the indication is not received, operation of the method 1100 may return to block 1105, where use of the at least one active interface may continue, and/or a wait state may be entered for some period of time. However, when the indication to use the at least one additional interface has been received, operation of the method 1100 may continue to block 1125. In some cases, the indication may take the form of an indication that one or more of the active interfaces (e.g., a cellular interface) is unable to provide increased bandwidth. In some embodiments, the determination made at block 1120 may be made by the indication analysis sub module 525 described with reference to FIG. 5.

At block 1125, and based at least in part upon detecting the need for increased bandwidth and/or receiving the indication to use the at least one additional interface, the at least one additional interface may be added for use in the wireless communications. In some cases, one additional interface may be activated at a time. In some embodiments, the operation(s) at block 1125 may be performed using the interface activation/deactivation module 410 described with reference to FIGS. 4 and/or 5.

At block 1130, more than one of the active interfaces of the UE 115 may be simultaneously used for the wireless communications. The active interfaces may be used independent of network coordination of the active interfaces. In some embodiments, the operation(s) at block 1130 may be performed using the interface management module 210 described with reference to FIGS. 2, 4, and/or 5.

In some embodiments, the active interfaces of the UE 115 may be interfaces such as the interfaces 305 described with reference to FIG. 3. In some cases, the at least one active interface at block 1105 may be or include a WLAN interface and the at least one additional interface activated at block 1125 may be or include a cellular interface. In other cases, the at least one active interface at block 1105 may be or include a cellular interface and the at least one additional interface activated at block 1125 may be a WLAN interface. Alternately, the interfaces may take other forms.

Therefore, the method 1100 may be used for managing interfaces for wireless communications. It should be noted that the method 1100 is just one implementation and that the operations of the method 1100 may be rearranged or otherwise modified such that other implementations are possible.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Techniques described herein may be used for various wireless communications systems such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA20001x, 1x, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS. LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description below, however, describes an LTE system for purposes of example, and LTE terminology is used in much of the description below, although the techniques are applicable beyond LTE applications.

The communication networks that may accommodate some of the various disclosed embodiments may be packet-based networks that operate according to a layered protocol stack. For example, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use Hybrid ARQ (HARQ) to provide retransmission at the MAC layer to improve link efficiency. At the Physical layer, the transport channels may be mapped to Physical channels.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration. A processor may in some cases be in electronic communication with a memory, where the memory stores instructions that are executable by the processor.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

A computer program product or computer-readable medium both include a computer-readable storage medium and communication medium, including any mediums that facilitates transfer of a computer program from one place to another. A storage medium may be any medium that can be accessed by a general purpose or special purpose computer. By way of example, and not limitation, computer-readable medium can comprise RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote light source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A method for managing interfaces for wireless communications, comprising:
using at least one active interface of a user equipment (UE) for the wireless communications;
detecting at the UE, while using the at least one active interface, a need for increased bandwidth for the wireless communications;
activating, based at least in part upon detecting the need for increased bandwidth, at least one additional interface of the UE for use in the wireless communications; and
simultaneously using more than one of the active interfaces of the UE for the wireless communications, the active interfaces being used independent of network coordination of the active interfaces.

2. The method of claim 1, wherein detecting the need for increased bandwidth comprises:
detecting a round trip time of wireless communications exceeds a threshold.

3. The method of claim 1, wherein detecting the need for increased bandwidth comprises:
detecting a size of a transmit queue exceeds a threshold.

4. The method of claim 1, wherein detecting the need for increased bandwidth comprises:
detecting a share of downlink resources in a system exceeds a threshold.

5. The method of claim 1, wherein detecting the need for increased bandwidth comprises:
detecting a ratio of achieved throughput over estimated available bandwidth exceeds a threshold.

6. The method of claim 1, wherein detecting the need for increased bandwidth comprises:
detecting information on at least one application running on the UE.

7. The method of claim 6, wherein detecting information on at least one application comprises:
detecting a particular application running in a foreground of an operating system of the UE.

8. The method of claim 6, wherein detecting information on at least one application comprises:
detecting a particular combination of applications running in an operating system of the UE.

9. The method of claim 1, wherein detecting the need for increased bandwidth comprises:
detecting poor video performance.

10. The method of claim 1, further comprising:
receiving, from a network, an indication that at least one active interface is unable to provide increased bandwidth; and
adding the at least one additional interface based at least in part on the indication.

11. The method of claim 1, further comprising:
balancing wireless communication loads across two or more of the active interfaces.

12. The method of claim 1, wherein at least one of the interfaces comprises a wireless local area network (WLAN) interface.

13. The method of claim 1, wherein at least one of the interfaces comprises a cellular interface.

14. An apparatus for managing interfaces for wireless communications, comprising:
means for using at least one active interface of a user equipment (UE) for the wireless communications;
means for detecting at the UE, while using the at least one active interface, a need for increased bandwidth for the wireless communications;
means for activating, based at least in part upon detecting the need for increased bandwidth, at least one additional interface of the UE for use in the wireless communications; and
means for simultaneously using more than one of the active interfaces of the UE for the wireless communications, the active interfaces being used independent of network coordination of the active interfaces.

15. The apparatus of claim 14, wherein the means for detecting the need for increased bandwidth comprises:
means for detecting a round trip time of wireless communications exceeding a threshold.

16. The apparatus of claim 14, wherein the means for detecting the need for increased bandwidth comprises:
means for detecting a size of a transmit queue exceeding a threshold.

17. The apparatus of claim 14, wherein the means for detecting the need for increased bandwidth comprises:
means for detecting a share of downlink resources in a system exceeding a threshold.

18. The apparatus of claim 14, wherein the means for detecting the need for increased bandwidth comprises:
means for detecting a ratio of achieved throughput over estimated available bandwidth exceeding a threshold.

19. The apparatus of claim 14, wherein the means for detecting the need for increased bandwidth comprises:
means for detecting information on at least one application running on the UE.

20. The apparatus of claim 19, wherein the means for detecting information on at least one application comprises:
means for detecting a particular application running in a foreground of an operating system of the UE.

21. The apparatus of claim 19, wherein the means for detecting information on at least one application comprises:
means for detecting a particular combination of applications running in an operating system of the UE.

22. The apparatus of claim 14, wherein the means for detecting the need for increased bandwidth comprises:
means for detecting poor video performance.

23. The apparatus of claim 14, further comprising:
means for receiving, from a network, an indication that at least one active interface is unable to provide increased bandwidth; and
means for adding the at least one additional interface based at least in part on the indication.

24. The apparatus of claim 14, further comprising:
means for balancing wireless communication loads across two or more of the active interfaces.

25. The apparatus of claim 14, wherein at least one of the interfaces comprises a wireless local area network (WLAN) interface.

26. The apparatus of claim 14, wherein at least one of the interfaces comprises a cellular interface.

27. An apparatus for managing interfaces for wireless communications, comprising:
a processor;
a memory in electronic communications with the processor, the memory embodying instructions, the instructions being executable by the processor to:
use at least one active interface of a user equipment (UE) for the wireless communications;
detect at the UE, while using the at least one active interface, a need for increased bandwidth for the wireless communications;
activate, based at least in part upon detecting the need for increased bandwidth, at least one additional interface of the UE for use in the wireless communications; and
simultaneously use more than one of the active interfaces of the UE for the wireless communications, the active interfaces being used independent of network coordination of the active interfaces.

28. The apparatus of claim 27, wherein the instructions to detect the need for increased bandwidth are executable by the processor to:
detect a round trip time of wireless communications exceeding a threshold.

29. The apparatus of claim 27, wherein the instructions to detect the need for increased bandwidth are executable by the processor to:
detect a size of a transmit queue exceeding a threshold.

30. The apparatus of claim 27, wherein the instructions to detect the need for increased bandwidth are executable by the processor to:
detect a share of downlink resources in a system exceeding a threshold.

31. The apparatus of claim 27, wherein the instructions to detect the need for increased bandwidth are executable by the processor to:
detect a ratio of achieved throughput over estimated available bandwidth exceeding a threshold.

32. The apparatus of claim 27, wherein at least one of the interfaces comprises a wireless local area network (WLAN) interface.

33. The apparatus of claim 27, wherein at least one of the interfaces comprises a cellular interface.

34. A computer program product for managing interfaces for wireless communications, the computer program product comprising a non-transitory computer-readable medium storing instructions executable by a processor to:
use at least one active interface of a user equipment (UE) for the wireless communications;
detect at the UE, while using the at least one active interface, a need for increased bandwidth for the wireless communications;
activate, based at least in part upon detecting the need for increased bandwidth, at least one additional interface of the UE for use in the wireless communications; and
simultaneously use more than one of the active interfaces of the UE for the wireless communications, the active interfaces being used independent of network coordination of the active interfaces.

35. The computer program product of claim 27, wherein the instructions to detect the need for increased bandwidth are executable by the processor to:
detect a round trip time of wireless communications exceeding a threshold.

36. The computer program product of claim 27, wherein the instructions to detect the need for increased bandwidth are executable by the processor to:
detect a size of a transmit queue exceeding a threshold.

37. The computer program product of claim 27, wherein the instructions to detect the need for increased bandwidth are executable by the processor to:
detect a share of downlink resources in a system exceeding a threshold.
